(19) United States
(12) Patent Application Publication
(10) Pub. No.: US 2006/0269812 A1
(43) Pub. Date: Nov. 30, 2006

(54) Process for producing a solid oxide fuel cell and product produced thereby

(76) Inventor: Franklin David Lemkey, Palm Beach Gardens, FL (US)

Correspondence Address: Louis E. Marn, 9 Edgewater Drive, Palm Coast, FL, 32164, US

(21) Appl. No.: 11/140,430

(22) Filed: May 27, 2005

(51) Int. Cl. H01M 8/12; B05D 5/12; H05B 6/00

(52) U.S. Cl. 429/30; 427/115; 264/458

(57) ABSTRACT

There is disclosed a process for forming a ceramic-based fuel cell by the use of electron beam vaporization of fuel cell components sequentially to form the anode, electrolyte and cathode elements under controlled processing conditions and the resulting ceramic-based fuel cell having anode and cathode layers of microporous columnar structures normal to the electrolyte layer.

### BACKGROUND OF THE INVENTION

1. Field of the Invention

This invention relates to solid oxide fuel cells, and more particularly to an improved process for forming a solid oxide fuel cell and the product produced thereby.

2. Description of the Prior Art

Solid oxide fuel cells differ, inter alia, from other fuel cells primarily since the anode, electrolyte and cathode are each comprised of solid ceramic alloys. Since the electrolyte must be an ion conductor, solid oxide fuel cells operate at elevated temperatures, e.g. 600-1000° C., to provide adequate oxygen ion conductivity. The solid electrolyte of such a fuel cell is simpler in design requiring only two phase (gas-solid) for the charge transfer reaction at the electrolyte-electrode interface. Since corrosion is essentially eliminated, a solid oxide fuel cell permits flexibility in cell design, particularly with regard to the use of planar or cylindrical geometry. Thus, reactant gas flow may flow in annular or radial spaces along the electrode surfaces. In U.S. Pat. No. 5,549,948 to Yamanis et el, is illustrative of a radial design wherein reactant gases diffuse through porous electrodes from the center to the periphery of the disc stack.

While solid oxide fuel cells possess many advantages over other types of fuel cells, manufacturing costs are high and processing technology tenuous. Additionally, the anode structure is subject to stresses as a result of cycling between on/off configurations thereby resulting in cracks and internal damage, generally at the interface between the anode and electrolyte layers, reducing re-generating capabilities.

### OBJECTS OF THE INVENTION

An object of the present invention is to provide an improved process for forming a solid oxide fuel cell.

Another object of the present invention is to provide an improved process for facilely forming a solid oxide fuel cell of improved structural integrity.

A still further object of the present invention is to provide an improved process for forming a solid oxide fuel cell at improved cost considerations.

Yet another object of the present invention is to provide a solid oxide fuel cell of improved structural integrity thereby enhancing useful life expectancy.

Still another object of the present invention is to provide a solid fuel cell of improved power density and efficiency.

### SUMMARY OF THE PRESENT INVENTION

These and other objects of the present invention are achieved by sequential use of electron beams to evaporate fuel cell components to form the fuel cell components, i.e., the anode, electrolyte and cathode elements of a solid oxide fuel cell under controlled processing conditions to form controlled and graded microporous structures of columnar porosity normal to the surface of the electrolyte interface.

### BRIEF DESCRIPTION OF THE DRAWINGS

Other objects and advantages of the present invention will become more readily apparent from the following detailed description thereof, when taken with the accompanying drawings, wherein:

FIG. 1 is schematic sectional side view of a processing vessel for effecting electron beam vaporization of components to form a solid oxide fuel cell; and

FIG. 2 is schematic cross-sectional view of the processing vessel taken along the line II-II of FIG. 1.

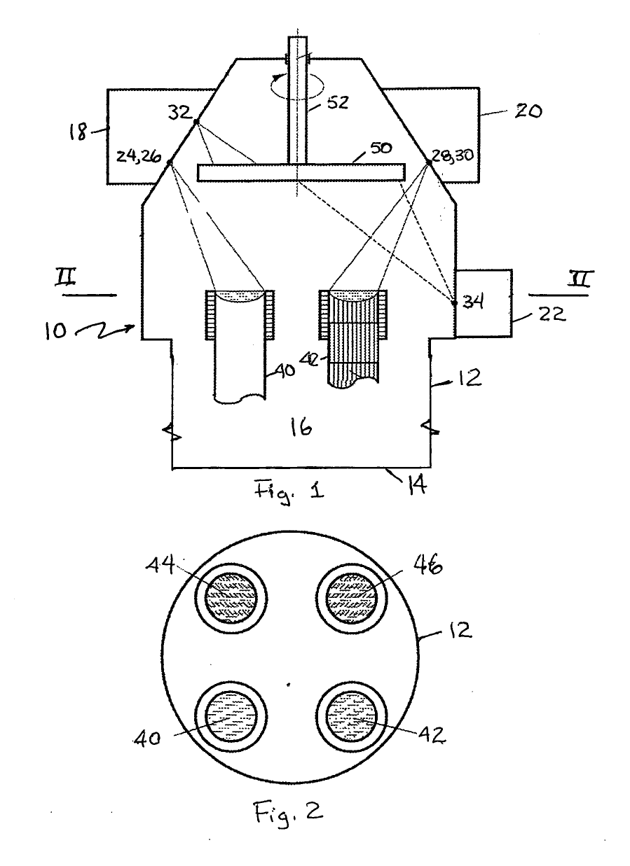

### DETAILED DESCRIPTION OF THE PRESENT INVENTION

Referring now to the drawings, there is illustrated a vacuum deposition vessel, generally indicated as 10, comprised of a generally cylindrically-shaped side wall 12 having a bottom wall 14 thereby defining a vaporization and deposition chamber 16 for effecting vaporization and deposition of ceramic fuel cell components, as more fully hereinafter discussed. The vacuum deposition vessel 10 is provided with a plurality of peripherially-disposed housing chambers 18, 20 and 22 positioned about an upper portion thereof for housing electron beam assemblies 24, 26, 28, 30, 32 and 34. The vacuum deposition vessel 10 is provided with a plurality of material supply containers 40, 42, 44 and 46 disposed in the chamber 16 thereof for receipt of fuel cell ceramic-based precursor materials, as more fully hereinafter discussed. A horizontally disposed substrate plate member 50 is mounted for rotation to a shaft 52 driven by a motor (not shown) in the upper portion of the vacuum deposition chamber 16 and above the supply containers 40, 42, 46 and 46.

Electron beam assemblies 24 and 26 in the housing chamber 18 are horizontally-spaced apart from one another with electron beam arrays thereof being directed to the supply containers 40 and 44, respectively. Electron beam assemblies 28 and 30 in the housing chamber 20 are horizontally-spaced apart from one another with electron beam arrays thereof being directed to the supply containers 42 and 46, respectively. The electron beam assembly 32 disposed in the housing chamber 18 is positioned for directing an electron beam array towards the upper surface of the plate member 50. The electron beam assembly 34 disposed in the housing chamber 22 is positioned for directing an electron beam array towards the lower surface of the plate member 50, as more fully hereinafter discussed.

The vacuum deposition vessel 10 is provided with pumps, valves and conduits (not shown) to effect a low pressure or vacuum in the range of from about 10⁻⁶ to 10⁻² torr., as well as conduits and the like (not shown) to continuously provide ceramic-based precursor compositions to the supply containers 40 to 46. Additionally, conduits (not shown) are provided to remove extraneous vapors from the vacuum deposition vessel 10.

In operation, a ceramic-based anodic precursor composition, such as ZrO₂(7Y₂O₃) is introduced into the supply container 40; an anodic additive, such as Ni, is introduced into the supply container 44; a ceramic-based cathodic precursor composition, such as (LSCF) or (La,Sr)Mn) where NaCl is introduced into the supply container 42 and a separation composition, such as CaF₂ is introduced into the supply container 46. The vacuum deposition vessel 10 is thereupon evacuated to a desired low pressure level, the plate member 50 is caused to be rotated and the electron beam assembly 42 is energized to direct an electron beam array onto the upper surface portion of the rotating plate member 50 to raised the temperature thereof to a condensation temperature of from about 600 to 1000° C.

Once achieving condensation temperature for the plate member 50, the electron beam assembly 30 is energized for a time sufficient to effect vaporization of CaF₂ in container 46 in an amount to form a thin layer of from 5-10 μm. Electron beam assemblies 24 and 26 are then energized to effect vaporization of the components in the supply containers 40 and 44 whereby condensation of a ceramic-based anodic composition is condensed on the rotating plate member 50 and is continued for a time sufficient to form microporous anode layer of a desired thickness of from about 10 to 125 μm., whereupon electron beam assembly 44 is deactivated to permit further deposition of an electrolyte layer of a desired thickness of from about 2 to 25 μm., before deactivation of the electron beam assembly 24.

Condensation of the ceramic-based anodic composition results in columnar structure or porosity thereof normal to the interface with the electrolyte layer. Accordingly, such columnar structures result in conduit like passages to facilitate oxygen ion flow. Electron beam assembly 34 is activated to heat the electrolyte layer to an elevated temperature, e.g. at least about 1400° C. for a time sufficient to densify the electrolyte layer at the desired thickness.

Electron beam assembly 34 is deactivated and the electron beam assembly 28 is activated with vaporization of the composition in container 42 and thence the deposition of a cathode layer on the densified electrolyte layer of a thickness of from 10 to 125 μm., at an achieved porosity level, preferably of at least about 30 vol %. Similarly, as hereinabove discussed, a columnar structure or porosity for the cathode is likewise achieved to provide conduit like passages for oxygen ion flow from the cathode to the anode. It is understood that a gradient in porosity (or chemical composition) is favorably influenced by operating conditions and thus changes localized electrochemical activity at the metal-electrolyte-gas three phase boundary. There is achieved unique control in the nano-meters scale providing for long term stability with the reactive electrode compositions.

A stack of three-layered ceramic fuel cells may be readily produced by positioning a spacer plate member on the cathode layer and repeating the processing step beginning with activation of the electron beam assemblies 24 and 26, etc., there being no need to form a separation layer as hereinabove described.

In accordance with the present invention based upon electron beam vaporization and deposition of differing precursor materials in a vacuum permits the formation of fuel cell electrodes with controlled and graded microporous structures of a thickness of from several μm to 1-2 mm. on planarized gas manifold or metallic interconnect substrates. Additionally, high vapor deposition rates of from 1200 to 1500 μm/hr are possible for alloys, ceramics and mixtures thereof.

A main mechanism of microporosity formation is based upon a “shadowing” effect where certain microrelief forms on the condensation surface during initiation and subsequent non-uniform growth rate of various crystallographic faces of nuclei. Such faces and microprotrusions, growing with maximum rate screen adjacent areas of the surface from vapor flow resulting in the formation of microvoids. Such “screening” effect is enhanced by the vapor incidence angle on the condensation surface is less than 90° or second phase particles nucleate and grow on the condensation surface. The structure (relief) of the condensation surface and as a consequence microporosity of the condensates may be varied over certain ranges by changing process parameters of deposition, i.e. substrate temperature, deposition rates, pressure levels and the like.

The addition of various materials to the vapor phase of the main components (or components) by simultaneous evaporation from a common source or simultaneous evaporation from another source is effective in varying microporosity. Second source additives may be group, generally, into three groups as a result of the extent of chemical interaction with the vapor phase and solid phase of the main components at the stages of condensate formation and subsequent heat treatments:

I. additives virtually not reacting with the main component and remaining in the condensate volume in the form of second phase particles;

II. additives essentially removed from the condensate during deposition; and

III. additives interacting with the main component through simple or complex reactions.

Some additives may be classified in different groups, depending on condensation temperature and rate. Generally, two kinds of microporosity are formed, i.e. open (connective) where the pores are contiguous and closed (disconnected) where the pores are isolated from each other. In accordance with the present invention it is most desirable that open porosity be produced at the electrode/electrolyte interfaces and more desirable to be graded with higher porosity present at the interface.

While the present invention has been described in connection with an exemplary embodiments thereof, it will be understood that may modifications thereof will be apparent to those of ordinary skill in the art and that this application is intended to cover any adaptations or variations thereof, and therefore it is manifestly intended that this invention be only limited by the claims and the equivalents thereof.

What is claimed is:

1. A process for producing a ceramic-based fuel cell in a vessel maintained under a vacuum from ceramic-based precursor compositions, which comprises the steps of:
a.) heating a substrate to a condensation temperature;
b.) sequentially vaporizing by electron beam array ceramic-based anodic, electrolyte and cathodic precursor compositions, respectively, for deposition on said heated substrate; and
c.) recovering said thus formed ceramic-based fuel cell from said substrate.

2. The process for producing a ceramic-based fuel cell as defined in claim 1 wherein sequential vaporization of a highly oxidation resistant metallic alloy is effected to provide electrical interconnection.

3. The process for producing a ceramic-based fuel cell as defined in claim 1 wherein said ceramic-based anodic precursor includes Nickel.

4. The process for producing a ceramic-based fuel cell as defined in claim 3 wherein nickel vaporization is discontinued to form said electrolyte layer.

5. The process for producing a ceramic-based fuel cell as defined in claim 1 wherein said electrolyte layer is heat treated to densify a surface portion prior to deposition of a cathode layer.

6. A process for producing a ceramic-based fuel cell in a vessel maintained under a vacuum, which comprises the steps of:
a.) heating a planar substrate to a condensation temperature for a ceramic-based compostion;
b.) heating by electron beam arrays a ceramic-based anodic precursor composition and an anodic additive to effect vaporization and deposition thereof onto said planar substrate for a time sufficient to form an anode layer;
c.) discontinuing heating of said anodic additive for a time sufficient to form an electrolyte layer;
d.) deactivating said electron electron beam array for said ceramic based anodic precursor compostion;
e.) heating by electron beam array said electrolyte layer for a time sufficient to densify a surface portion thereof; and
f.) heating by electron beam array a ceramic-based cathodic precursor composition to effect vaporization and deposition on said electrolyte layer to form a cathode layer and thus said ceramic-based fuel cell.

7. The process for producing a ceramic-based fuel cell as defined in claim 6 wherein step b) is effected for a time sufficient to form an anode layer of a thickness of from about 10 to 125 μm.

8. The process for producing a ceramic-based fuel cell as defined in claim 7 wherein step d) is effected after deposition of an electrolyte layer of a thickness of from 2 to 25 μm.

9. The process for producing a ceramic-based fuel cell as defined in claim 7 wherein step f) is effect for a time sufficient to form a cathode layer of a thickness of from about 10 to 125 μm.

10. A ceramic-based fuel cell, which comprises:
an anode formed of a ceramic-based composition including an anodic additive and having a columnar structure;
an electrolyte layer form of a ceramic-based composition deposited on said anode and having a densified surface; and
a cathode formed of a ceramic-based composition deposited on said densified surface of said electrolyte layer and having a columnar structure, said columnar structures being normal to said densified surface of said electrolyte layer.

11. The ceramic-based fuel cell as defined in claim 10 wherein said anode layer is of a thickness of from 10 to 125 μm.

12. The ceramic-based fuel cell as defined in claim 10 wherein said electrolyte layer is of a thickness of from 2 to 25 μm.

13. The ceramic-based fuel cell as defined in claim 10 wherein said cathode layer is of a thickness of from 10 to 125 μm.

14. The ceramic-based fuel cell as defined in claim 10 and further including a high temperature oxidation resistant alloy end plate as electrical interconnects.
